(19) United States
(12) Patent Application Publication
(10) Pub. No.: US 2011/0218092 A1
(43) Pub. Date: Sep. 8, 2011

(54) SHEET FOLDING MECHANISM, SHEET POST-PROCESSING APPARATUS AND METHOD THEREOF

(75) Inventors: Jun Ishii, Shizuoka (JP); Shinichiro Mano, Kanagawa (JP)

(73) Assignees: Kabushiki Kaisha Toshiba, Tokyo (JP); Toshiba Tec Kabushiki Kaisha, Tokyo (JP)

(21) Appl. No.: 13/034,419

(22) Filed: Feb. 24, 2011

Related U.S. Application Data
(60) Provisional application No. 61/311,257, filed on Mar. 5, 2010.
(60) Provisional application No. 61/318,241, filed on Mar. 26, 2010.
(60) Provisional application No. 61/318,244, filed on Mar. 26, 2010.

(51) Int. Cl. B31F 1/20; B65H 5/06; B65H 5/26; B41F 13/56

(52) U.S. Cl. 493/463; 271/272; 271/225; 270/20.1

(57) ABSTRACT

Certain embodiments provide a sheet folding mechanism including: a folding unit; a shaft; a pair of discharge rollers provided on the shaft; a pair of pinch rollers; a pair of clutches configured to transmit a rotational force only in the reverse direction; a pair of corrugation rollers, each of the corrugation rollers having a cam surface including a first diameter portion and a second diameter portion on an outer peripheral surface thereof, and an eccentric bearing to be fixed to each of the pair of clutches; a lock member configured to prevent the pair of corrugation rollers from idling; a drive unit configured to rotate the shaft; and a controller configured to cause the corrugation rollers to apply corrugation on the sheet bundle using any one of the first diameter portions and the second diameter portions according to the number of sheets in the sheet bundle.

### CROSS-REFERENCE TO RELATED APPLICATION

The present application claims priority under 35 U.S.C. 119 to U.S. Provisional Application Ser. Nos. 61/311,257, to ISHII, filed on Mar. 5, 2010, 61/318,241, to MANO, filed on Mar. 26, 2010 and 61/318,244, to ISHII, filed on Mar. 26, 2010, the entire disclosure of which is incorporated herein by reference.

### FIELD

An embodiment relates to a sheet folding mechanism, a sheet post-processing apparatus, and a method of applying corrugation on a sheet.

### BACKGROUND

A sheet post-processing apparatus is connected to an image forming apparatus. The sheet post-processing apparatus has a saddle-stitch function in addition to functions of sorting and stapling.

A saddle machine produces booklets by folding sheet bundles at a center. Discharge rollers in the saddle machine apply corrugation on a sheet. The term “corrugation” means to fold into alternate troughs and ridges, or the alternate troughs and ridges themselves.

A corrugation roller enhances the rigidity of the sheet. The corrugation roller allows the sheet to advance easily straight ahead.

However, if the corrugation roller applies too deep corrugation to a booklet having a small number of sheets, the booklet may be subjected to breakage.

If the corrugation roller applies too light corrugation to a booklet having a large number of sheets, corrugation applied to the booklet is insufficient.

### BRIEF DESCRIPTION OF THE DRAWINGS

FIG. 1 is a configuration drawing showing a sheet post-processing apparatus according to a first embodiment;

FIG. 2 is a perspective view of an additional folding unit used in the sheet post-processing apparatus according to the first embodiment;

FIG. 3 is a perspective view of a roller unit in the additional folding unit used in the sheet post-processing apparatus according to the first embodiment;

FIG. 4A is a drawing showing a structure of a cross section of the roller unit shown in FIG. 3 at a home position;

FIG. 4B is a drawing showing a structure of a cross section of the roller unit shown in FIG. 3 in a state of being moved;

FIG. 5 is a drawing showing an example of a structure of a drive unit in the additional folding unit used in the sheet post-processing apparatus according to the first embodiment;

FIG. 6 is a perspective view of a sheet folding mechanism according to the first embodiment;

FIG. 7A is a drawing showing a crutch used in the sheet folding mechanism according to the first embodiment in a state in which a rotational force in the normal direction is applied;

FIG. 7B is a drawing showing the crutch used in the sheet folding mechanism according to the first embodiment in a state in which a rotational force in the reverse direction is applied;

FIG. 8A is a drawing showing a state in which a sheet bundle is inserted into the sheet folding mechanism according to the first embodiment;

FIG. 8B is a drawing showing a state in which the sheet bundle is advanced to a frontmost position in the sheet folding mechanism according to the first embodiment;

FIG. 8C is a drawing showing a state in which the sheet bundle is started to return from the sheet folding mechanism according to the first embodiment;

FIG. 8D is a drawing showing a state in which a corrugation roller of the sheet folding mechanism according to the first embodiment is reversely rotated;

FIG. 9A is a drawing showing small corrugation that the sheet folding mechanism according to the first embodiment applies to the sheet bundle;

FIG. 9B is a drawing showing large corrugation that the sheet folding mechanism according to the first embodiment applies to the sheet bundle;

FIG. 10 is a drawing showing an axial cross-sectional structure of a sheet folding mechanism according to a first modification;

FIG. 11 is a perspective view of a sheet folding mechanism according to a second modification;

FIG. 12 is a drawing for explaining a reciprocal movement control of a pair of upper and lower additional-folding rollers used in a sheet post-processing apparatus according to a second embodiment;

FIG. 13A is a front view of a sheet folding mechanism according to a third embodiment;

FIG. 13B is a top view of the sheet folding mechanism according to the third embodiment;

FIG. 14A is a perspective view of a holder used in the sheet folding mechanism according to the third embodiment; and

FIG. 14B is an enlarged view of a D-cut portion formed on a shaft used in the sheet folding mechanism according to the third embodiment.

### DETAILED DESCRIPTION

Certain embodiments provide a sheet folding mechanism including: a folding unit configured to form a folding line by folding a center of a sheet bundle having a plurality of sheets; a shaft positioned on an output side of the folding unit and having a horizontal shaft axis orthogonal to the carrying direction in which the sheet bundle is carried; a pair of discharge rollers provided on the shaft in the longitudinal direction thereof; a pair of pinch rollers configured to nip the sheet bundle in cooperation with the pair of discharge rollers; a pair of clutches configured to transmit a rotational force about the shaft axis only in a reverse direction opposite from a normal direction which causes the sheet bundle to be discharged; a pair of corrugation rollers, each of the corrugation rollers having a cam surface including a first diameter portion having a diameter larger than a diameter of the discharge roller and a second diameter portion having a diameter smaller than the diameter of the first diameter portion on an outer peripheral surface thereof, and an eccentric bearing to be fixed to each of the pair of clutches inside the outer peripheral surface; a lock member configured to prevent the pair of corrugation rollers from idling about the shaft axis in the direction to cause the sheet bundle to be discharged; a drive unit configured to rotate the shaft in the normal direction and the reverse direction, and a controller configured to control driving of the drive unit and cause the corrugation rollers to apply corrugation on the sheet bundle using any one of the first diameter portions and the second diameter portions according to the number of sheet in the sheet bundle.

Referring now to attached drawings as examples, a sheet folding mechanism, a sheet post-processing apparatus, and a method of applying corrugation on a sheet will be described in detail. In respective drawings, the same parts are designated by the same reference numerals and overlapped descriptions are omitted.

### First Embodiment

A sheet post-processing apparatus according to a first embodiment is a finisher. A sheet folding mechanism according to the first embodiment is a mechanism positioned on the discharging side of the finisher and folding sheet bundles at a center thereof by applying corrugation to the sheet bundle.

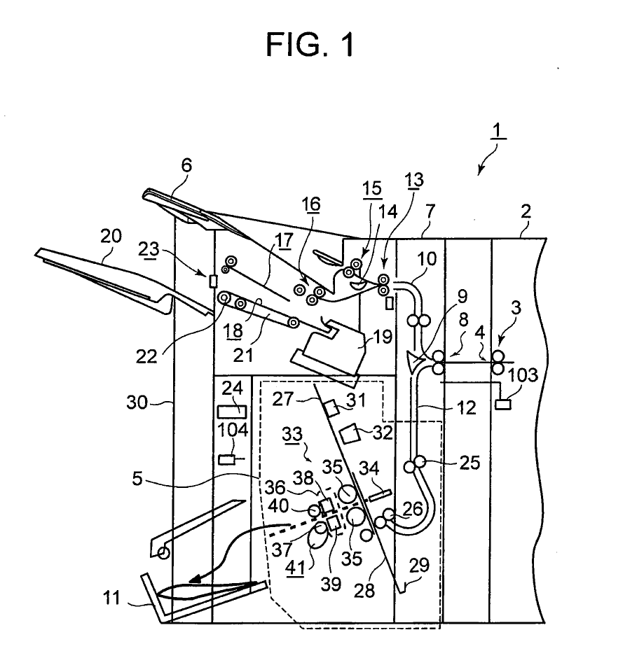

FIG. 1 is a drawing showing an example of an internal structure of the finisher. A finisher 1 performs a post process on sheets printed and output from an MFP 2.

The term “post process” means stacking and stapling the sheets, saddle-stitching the sheet bundle, and folding the same at the center.

The MFP 2 includes a pair of outlet port rollers 3. The outlet port rollers 3 discharge the sheet from a discharging port 4.

The finisher 1 includes a sheet branching portion 7 configured to divide the sheets to any one of the side of a saddle machine 5 or the side of a fixed tray 6.

The sheet branching portion 7 includes a supply port 8 connected to the discharging port 4, a branching member 9 configured to guide sheets to one of upper and lower path, an upper sheet carrying path 10 continuing to the fixed tray 6, and a lower sheet carrying path 12 continuing to a saddle tray 11.

The finisher 1 includes a pair of inlet port rollers 13 to which sheets are supplied from the upper sheet carrying path 10, and a branching member 14 configured to switch the paths for sheets. The branching member 14 guides sheets from the inlet port rollers 13 to upper or lower carrying paths.

When the finisher 1 does not staple, the branching member 14 guides sheets to a pair of final rollers 15. The final rollers 15 discharge the sheets onto the fixed tray 6. When the finisher 1 staples, the branching member 14 guides sheets to a pair of paper feeding rollers 16.

The finisher 1 includes a standby tray 17 downstream of the paper feeding rollers 16 in the carrying direction. The finisher 1 includes a processing tray 18, a stapler 19, and a paper discharge tray 20.

The standby tray 17 aligns sheets. The standby tray 17 causes the sheets to drop by its own weight. The processing tray 18 guides the dropped sheets to the stapler 19. The stapler 19 staples a sheet bundle.

The processing tray 18 includes a carrying belt 21 and a discharge roller 22. The carrying belt 21 carries sorted and stapled sheets to the paper discharge tray 20. The carrying belt 21 discharges the sheets from a discharging port 23 to the paper discharge tray 20.

The finisher 1 includes a controller 24 configured to control the entire finisher 1. The controller 24 controls driving of a plurality of motors. The controller 24 controls the direction of rotation, the amount of rotation, and timing of rotation.

The controller 24 controls the operations of the saddle machine 5 and the sheet branching portion 7.

The finisher 1 includes a receiving unit 104. The receiving unit 104 receives control signals by UART (Universal Asynchronous Receiver/Transmitter) communication with a transmitting unit 103 of the MFP 2.

The receiving unit 104 receives the number of sheets printed and output by the MFP 2. The controller 24 acquires information on the number of sheets from the MFP 2 using the receiving unit 104.

The controller 24 includes a CPU (Central Processing Unit), a ROM (Read Only Memory), and a RAM (Random Access Memory). The ROM stores programs describing operation sequences, control values for a plurality of the motors, and threshold values for comparison operation.

The finisher 1 carries the sheets to the saddle machine 5 by the branching member 9. The saddle machine 5 is a saddle unit configured to stitch the center of sheets and fold the center of a sheet bundle.

The saddle machine 5 folds the center of the sheet bundle. The saddle machine 5 may drive needles into two points in the vicinity of the center of one side of the sheet bundle. The saddle machine 5 outputs a bound booklet to the saddle tray 11.

The saddle machine 5 sends a single sheet to a pair of intermediate rollers 25. The intermediate rollers 25 send the sheet to a pair of outlet port rollers 26. The outlet port rollers 26 feed the sheet to a tray 27. A surface of the tray 27 is inclined.

The finisher 1 includes a stacker 28 below the tray 27. The finisher 1 reciprocates the stacker 28 in the sheet carrying direction. The stacker 28 has a stopper 29. The stopper 29 receives the sheet dropping from obliquely upward of the tray 27.

The stacker 28 stacks the sheets dropping from the tray 27. The stacker 28 produces a sheet bundle and aligns a lower end of the sheet bundle.

The saddle machine 5 includes a pair of tray panels 31 in the direction of the depth of a machine body 30. The tray panel 31 aligns the sheet bundle in the direction orthogonal to the sheet carrying direction. The finisher 1 includes a stapler 32 at a midsection of the tray 27.

The controller 24 causes the tray 27 to adjust a position of the stacker 28 before stapling the sheet bundle.

The finisher 1 includes a folding unit 33. The folding unit 33 includes a blade 34, and a pair of folding rollers 35 positioned respectively forward of the blade 34 in the direction of travel. The blade 34 has a length in the direction of a width of the sheet.

The stapler 32 staples the center of the sheet bundle. The controller 24 moves the stacker 28 downward until a position in which a staple is driven reaches a position in front of the blade 34.

A position where a folding line is to be formed reaches the position in front of the blade 34. A distal end of the blade 34 pushes a centerline of the sheet bundle. The folding unit 33 folds the sheet bundle so that a sheet surface pushed by the blade 34 faces inside.

The folding rollers 35 form a nip therebetween. The folding rollers 35 form a folding line on the sheet bundle while gripping the sheet bundle.

The finisher 1 includes an additional folding unit 36 downstream of the folding rollers 35 in the sheet carrying direction. The additional folding unit 36 includes an upper additional folding roller 38 and a lower additional folding roller 39.

The upper additional folding roller 38 and the lower additional folding roller 39 move while pressing the folding line in the direction orthogonal to the carrying direction of the sheet. The upper additional folding roller 38 and the lower additional folding roller 39 move along the folding line. The additional folding unit 36 outputs the sheet bundle while sharpening the folding line.

The finisher 1 includes a horizontal pair of discharge rollers 37, a horizontal pair of pinch rollers 40, and a horizontal pair of corrugation rollers 41.

The discharge rollers 37 are saddle discharge rollers.

The pinch rollers 40 pinch the booklet in cooperation with the discharge rollers 37.

The corrugation rollers 41 apply corrugation to the sheet bundle. The corrugation rollers 41 form troughs and ridges on the sheets at a constant amplitude.

The pinch rollers 40 and the corrugation rollers 41 feed the sheet bundle while pinching the booklet. The corrugation rollers 41 and the discharge rollers 37 commonly use a shaft 43.

The discharge rollers 37 output the corrugated sheets to the saddle tray 11. The saddle tray 11 accumulates the sheet bundles.

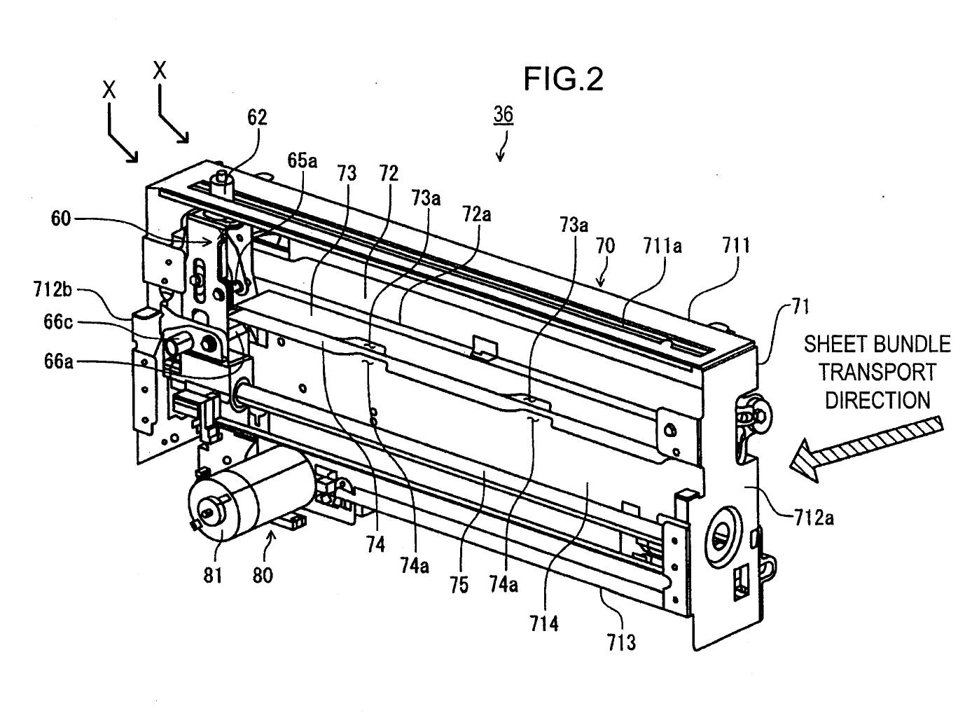

FIG. 2 is a perspective view of the additional folding unit 36. The additional folding unit 36 includes a roller unit 60, a body 70, and a drive mechanism 80.

The roller unit 60 moves leftward and rightward in the body 70. The roller unit 60 sharpens the bent folding line of the sheet bundle.

The body 70 is a supporting unit configured to support the roller unit 60. The drive mechanism 80 includes a motor 81 for moving the roller unit 60.

The direction of movement of the roller unit 60 is a direction orthogonal to the carrying direction of the sheet. The upper additional folding roller 38 and the lower additional folding roller 39 exert a pressure on the folding line of the sheet bundle. The upper additional folding roller 38 and the lower additional folding roller 39 reciprocate along the folding line.

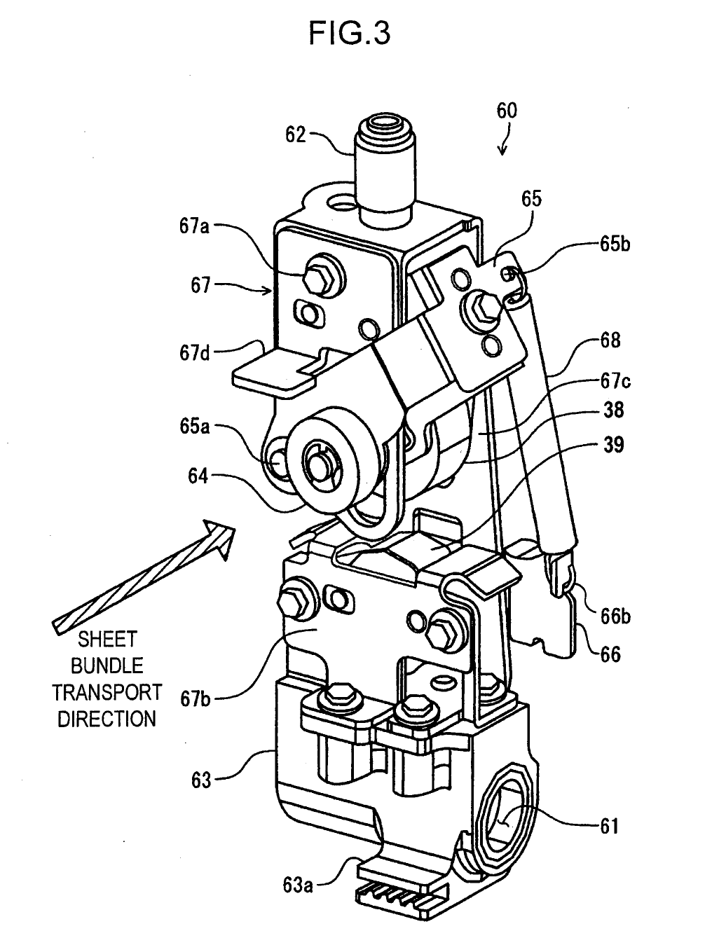

FIG. 3 is a perspective view of the roller unit 60. FIG. 3 shows an example viewed from an opposite side from that in the example shown in FIG. 2. Reference signs which are already described indicate the same components.

The roller unit 60 includes the upper additional folding roller 38 and the lower additional folding roller 39 in the interior thereof.

The roller unit 60 includes a unit supporting portion 63 at a lower portion thereof. The roller unit 60 includes a unit frame 67 and a supporting roller 62 at an upper portion thereof.

The unit supporting portion 63 includes a through hole 61.

The unit frame 67 includes an upper frame 67a, a lower frame 67b, and a plate 67c.

The upper frame 67a accommodates the upper additional folding roller 38. The lower frame 67b accommodates the lower additional folding roller 39. The plate 67c combines the upper frame 67a and the lower frame 67b.

The roller unit 60 includes an upper link member 65, a lower link member 66, and a coil spring 68. Ends of the coil spring 68 combine the upper link member 65 and the lower link member 66.

The coil spring 68 engages a through hole 65b and a notch 66b. The lower link member 66 includes a freely rotatably guide roller 66c.

The lower frame 67b axially supports the lower additional folding roller 39. The lower additional folding roller 39 rotates freely.

The lower frame 67b fixes the lower link member 66. The lower link member 66 is rotatably about a shaft 66a (FIG. 2).

A shaft 65a is fixed to the upper link member 65 (not the upper frame 67a). The upper link member 65 is obliquely fixed. The upper additional folding roller 38 rotates about the shaft 65a.

The lower frame 67b axially supports the lower additional folding roller 39. In other words, the unit frame 67 axially supports the lower additional folding roller 39. The position of the lower additional folding roller 39 does not move in the vertical direction when the roller unit 60 is moved.

A position of an upper end of the lower additional folding roller 39 is adjusted to be the same height as a film 74 (FIG. 2). When the roller unit 60 moves, the lower additional folding roller 39 rotates while keeping in contact with a lower surface of the film 74.

In contrast, the roller unit 60 moves away from its home position and starts moving. The upper link member 65 is pulled by the coil spring 68 and starts rotating about the shaft 65a.

With this rotation, the upper additional folding roller 38 starts moving downward. The upper additional folding roller 38 moves to a position coming in contact with the lower additional folding roller 39.

A force generated by a tensile force of the coil spring 68 acts mutually on the upper additional folding roller 38 and the lower additional folding roller 39. The upper additional folding roller 38 and the lower additional folding roller 39 pinch the sheet bundle with the intermediary of the films 73 and 74.

The upper additional folding roller 38 and the lower additional folding roller 39 additionally fold the folding line of the sheet bundle by the force applied between these rollers.

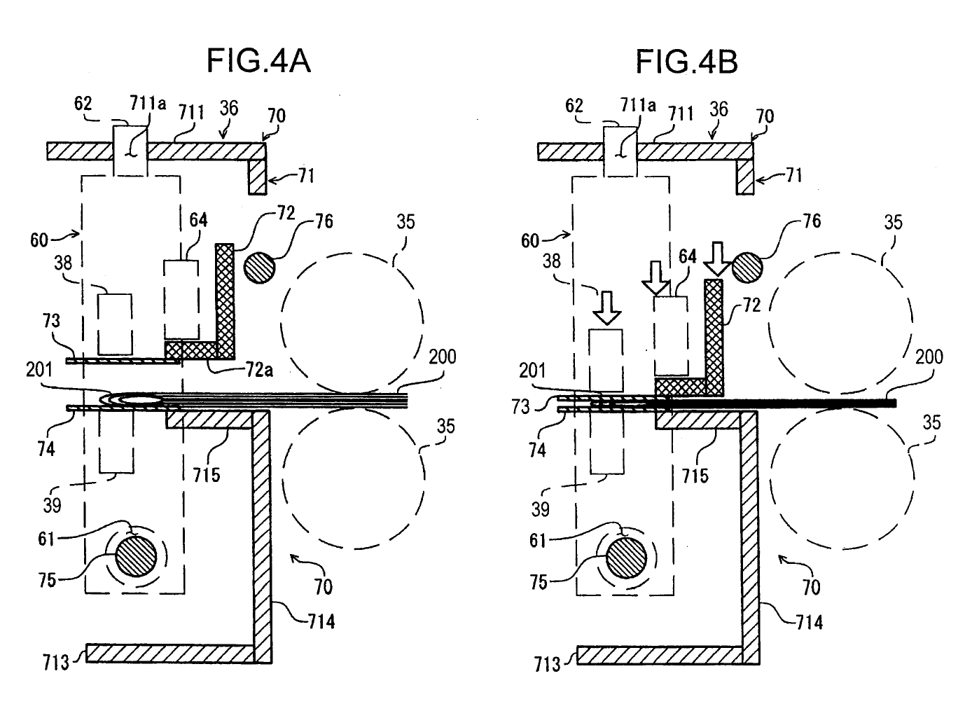

FIGS. 4A and 4B show a vertical cross-sectional structure of the body 70 taken along a line x-x in FIG. 2. Reference signs which are already described indicate the same components.

FIG. 4A is a drawing showing a structure of a cross section of the roller unit 60 at a home position. FIG. 4B is a drawing showing a structure of a cross section of the roller unit 60 while moving.

The body 70 includes a frame 71. The frame 71 includes a top panel 711, a left side panel 712a (FIG. 2), a right side panel 712b, a bottom panel 713, a back panel 714, and an intermediate panel 715.

The body 70 includes a slit 711a on the top panel 711. The slit 711a guides an upper portion of the roller unit 60 in the direction of the slit. The slit 711a and the supporting roller 62 cause the roller unit 60 to maintain its position.

The body 70 includes a shaft 75, a guide 72, and another shaft 76 between the left side panel 712a and the right side panel 712b.

The shaft 75 supports the roller unit 60. The guide 72 guides the roller unit 60. The shaft 76 moves the guide 72 in the vertical direction.

The guide 72 includes a bottom plate 72a and the film 73. The film 73 is formed of synthetic resin such as polyethylene terephthalate (PET).

The intermediate panel 715 includes the other film 74. The film 74 is substantially the same as the film 73. The intermediate panel 715 allows the sheet bundle to be placed thereon.

The folding rollers 35 feed the sheet bundle to the additional folding unit 36. The films 73 and 74 pinch a fold line 201 of a sheet bundle 200 without giving damage to it.

The upper additional folding roller 38 and the lower additional folding roller 39 additionally fold the fold line 201 via the films 73 and 74.

The films 73 and 74 have notches 73a and 74b respectively. The notches 73a and 74b prevent the films 73 and 74 from becoming damaged by a staple at the fold line 201.

The shaft 75 penetrates through the through hole 61 (FIG. 3) of the roller unit 60.

A pair of the shaft 75 and the through hole 61 and a pair of the slit 711a and the supporting roller 62 cause the roller unit 60 to maintain its position.

The structure of the drive mechanism 80 will be described.

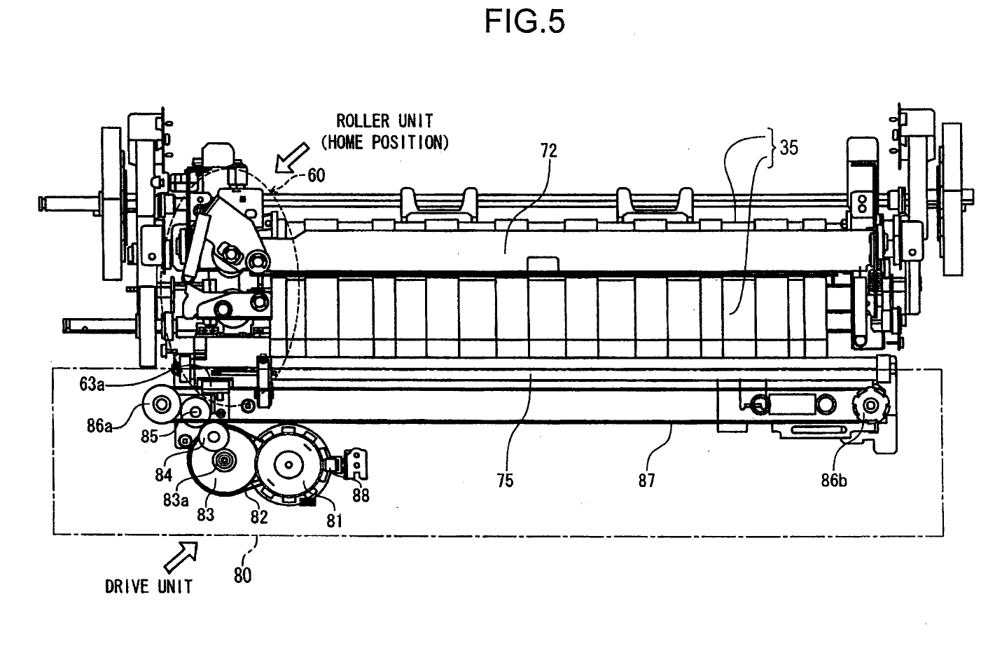

FIG. 5 is a drawing showing an example of a structure of the drive mechanism 80. Reference signs which are already described indicate the same components. FIG. 5 shows an example of a direction viewing from the destination toward an original position of the sheet bundle. The roller unit 60 at its home position, the pair of folding rollers 35, and a drive mechanism of the pair of folding rollers 35 are also shown.

The drive mechanism 80 includes the motor 81 as a unique drive source of the additional folding unit 36.

The drive mechanism 80 includes a motor belt 82 entrained about the motor 81 and a pulley 83. The pulley 83 includes a gear 83a. The drive mechanism 80 includes the gear 83a, a gear 84, a gear 85, and another pulley 86a.

The drive mechanism 80 includes a belt 87 entrained about the pulley 86a and a driven pulley 86b. The belt 87 is a driving belt. A drive force of the motor 81 causes the belt 87 to travel between the pulley 86a and the driven pulley 86b.

The belt 87 includes a rack on a belt surface. The rack engages teeth of a fitting portion 63a (FIG. 3) at a lower portion of the roller unit 60. The drive mechanism 80 reciprocates the roller unit 60 using the belt 87.

The controller 24 controls the direction of rotation and a speed of the motor 81. The drive mechanism 80 varies a traveling distance and a speed of the roller unit 60 using the controller 24.

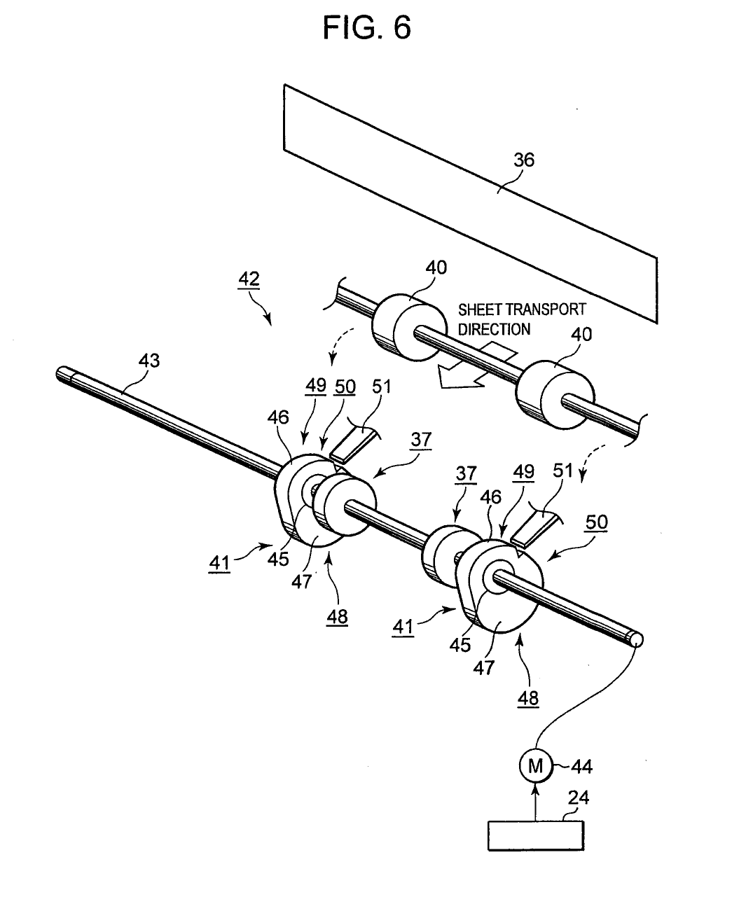

FIG. 6 is a perspective view of a sheet folding mechanism. Reference signs which are already described indicate the same components.

A sheet folding mechanism 42 includes the shaft 43, a motor 44 (drive unit), the horizontal pair of discharge rollers 37, and the horizontal pair of pinch rollers 40.

The shaft 43 includes a horizontal axis of rotation which is orthogonal to the carrying direction of the sheet bundle. The sheet folding mechanism 42 causes the shaft 43 to be axially supported, for example, in the saddle machine 5.

The motor 44 is a drive unit configured to rotate the shaft 43. The motor 44 rotates the shaft 43 in the sheet bundle feeding direction and the direction opposite from the feeding direction. The controller 24 controls the drive of the motor 44.

The sheet folding mechanism 42 includes the discharge rollers 37 at a distance from each other on the shaft 43.

The pinch rollers 40 forms a nip for the sheet bundle in cooperation with the discharge rollers 37. The sheet folding mechanism 42 includes the pinch rollers 40 so that a distance between the pinch rollers 40 is substantially equal to the distance between the discharge rollers 37.

The sheet folding mechanism 42 includes a pair of one-way clutches 45 on the shaft 43. The clutches 45 transmit a rotational force of the shaft 43 generated by the motor 44 only in the reverse direction.

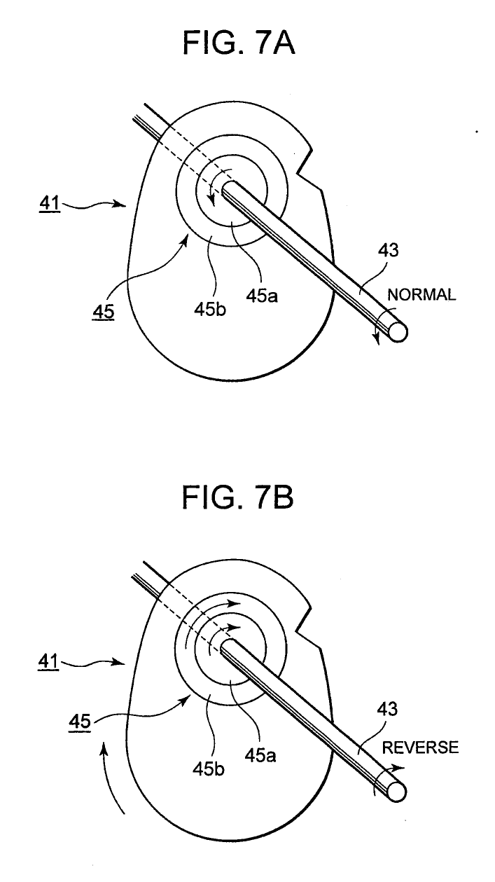

FIG. 7A is a drawing showing the clutch 45 which receives the rotational force in the normal direction from the shaft 43. Reference signs which are already described in FIGS. 7A and 7B indicate the same components.

The clutch 45 includes an inner member 45a fixed to an outer peripheral surface of the shaft 43 and an outer member 45b, which rotates relatively with respect to the inner member 45a, on the outside of the inner member 45a.

The shaft 43 exerts the rotational force in the normal direction on the inner member 45a. The outer member 45b does not rotate. The corrugation rollers 41 do not rotate.

FIG. 7B is a drawing showing the clutch 45 which receives the rotational force in the reverse direction from the shaft 43.

The shaft 43 exerts the rotational force in the reverse direction on the inner member 45a. The outer member 45b takes the inner member 45a along. The corrugation rollers 41 rotate.

The clutch 45 transmits only the rotational force in the reverse direction exerted on the shaft 43 from the inner member 45a to the outer member 45b.

The sheet folding mechanism 42 shown in FIG. 6 includes the pair of corrugation rollers 41. The corrugation rollers 41 include the pair of the clutches 45 on the inner peripheral sides thereof.

The corrugation rollers 41 each include a curved surface 46 which applies corrugation to the sheet bundle and a side surface 47 different from the curved surface 46. An outline of the side surface 47 has a cam profile of an eccentric cam.

The cam profile includes a large-diameter portion 48 (first diameter) having a turning radius larger than a roller diameter of the discharge rollers 37, a small-diameter portion 49 (second diameter) having a smaller diameter than the large-diameter portion 48, and a shouldered portion 50. The shouldered portion 50 connects the large-diameter portion 48 and the small-diameter portion 49.

The sheet folding mechanism 42 includes lock members 51 which lock the shouldered portions 50 respectively. The lock members 51 prevent the corrugation rollers 41 from rotating in the sheet bundle feeding direction with respect to the shaft 43.

The sheet folding mechanism 42 includes the lock members 51 so as to project, for example, from a frame in the saddle machine 5.

The controller 24 of the finisher 1 having the configuration as described thus far receives information from the MFP 2, indicating the sheet size, the number of sheets, the direction of the sheets to be printed and output and the presence or absence of the saddle-stitching or folding at the center.

### (1) When the Number of Sheets in a Booklet is Small

As shown in FIGS. 1 to 6, the controller 24 starts carrying the sheet bundle with respect to the sheet branching portion 7 and the saddle machine 5.

The controller 24 rotates the folding rollers 35. The folding rollers 35 carry the sheet bundle to the additional folding unit 36 in the carrying direction. The additional folding unit 36 includes two photo sensors.

The controller 24 senses a leading edge of the sheet bundle on the carrying path by a first photo sensor. The folding rollers 35 further carry the sheet bundle. The folding rollers 35 stop rotating when the number of pulses of an encoder of a motor 52 reaches a predetermined value.

The controller 24 commands the rotation of the motor 81. The additional folding unit 36 starts moving the roller unit 60 from its home position.

The controller 24 senses the fact that the roller unit 60 leaves the home position by a second photo sensor.

The motor 81 further moves the roller unit 60. The motor 81 stops rotation when the number of pulses of an encoder of the motor 81 reaches a predetermined value.

The roller unit 60 stops on the opposite side from the home position. The controller 24 counts a stopping time. After the elapse of the stopping time, the motor 81 starts rotating in the opposite direction. The roller unit 60 moves toward its home position.

The controller 24 senses the fact that the roller unit 60 approaches its home position by the second photo sensor. After the sensing, the motor 81 rotates by a predetermined number of pulses. The controller 24 stops movement of the roller unit 60.

The upper additional folding roller 38 and the lower additional folding roller 39 hold the folding line. The additional folding unit 36 sharpens the folding line of the sheet bundle. The additional folding unit 36 discharges the sheet bundle.

The controller 24 holds a threshold value of the number of sheets in advance. When the number of sheets notified by the MFP 2 is smaller than the threshold value, the controller 24 causes the motor 44 of the sheet folding mechanism 42 to rotate in the normal direction.

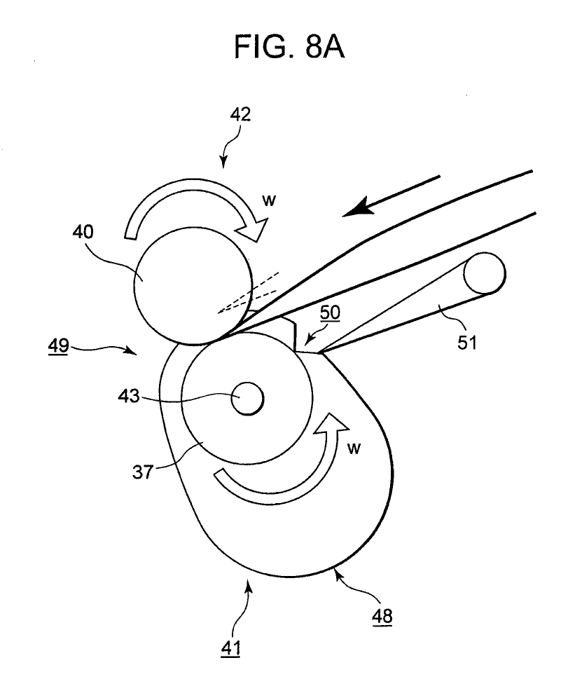

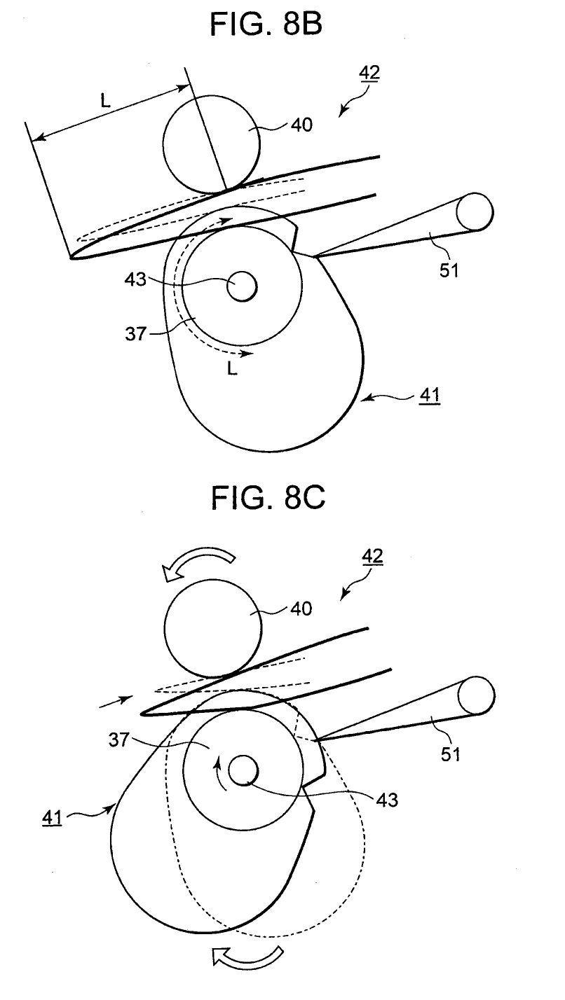

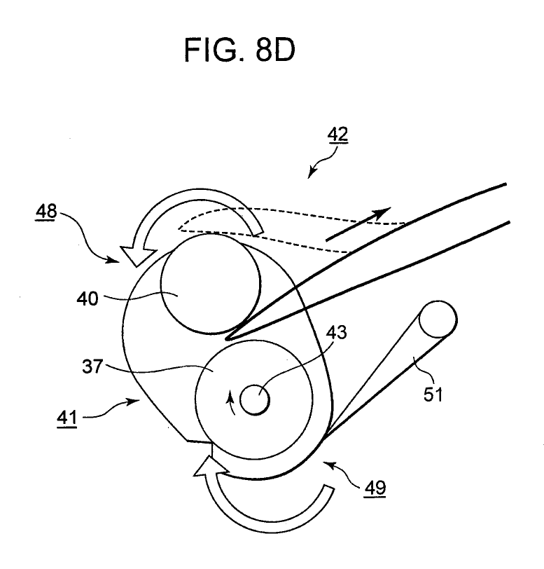

FIG. 8A is a drawing showing an axial cross-sectional structure of the sheet folding mechanism 42 in a state in which the sheet bundle is pushed in. Reference signs which are already described indicate the corresponding components.

FIG. 8A shows an example of viewing an end of the shaft 43 from the center thereof.

The sheet folding mechanism 42 rotates the discharge rollers 37 only in a normal direction w. The sheet folding mechanism 42 rotates the pinch rollers 40 in the normal direction w.

The sheet folding mechanism 42 causes the discharge rollers 37 and the pinch rollers 40 to discharge the sheet bundle from the additional folding unit 36. The sheet folding mechanism 42 presses the small-diameter portions 49 of the corrugation rollers 41 against the sheet surface of the sheet bundle.

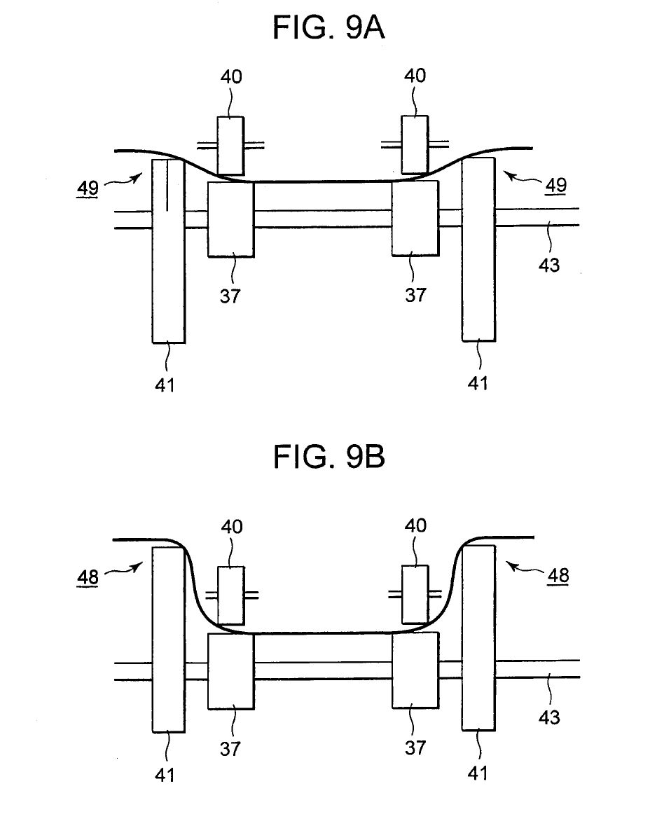

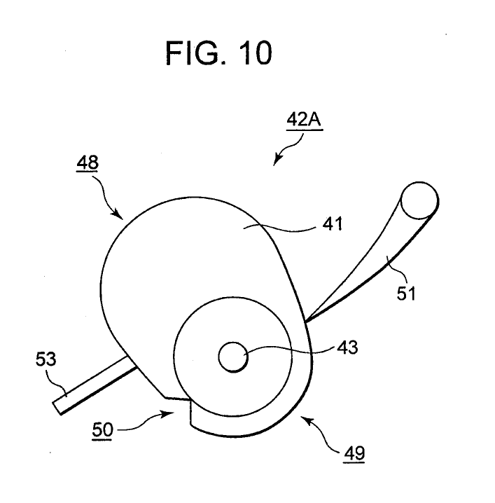

FIG. 9A is a drawing showing light corrugation that the sheet folding mechanism 42 applies to the sheet bundle. FIG. 9A is a front view of the sheet folding mechanism 42.

The cam surface of the corrugation rollers 41 forms a certain numbers of troughs and ridges on the sheet. The troughs and ridges appear alternately in the direction of the sheet width. The sheet bundle is bent so that ridge lines and trough lines appear in the longitudinal direction of the sheet.

The corrugation rollers 41 smoothen discharging operation of the sheet. The corrugation rollers 41 facilitate the alignment of the sheets after discharge.

As a matter of fact, since the small-diameter portions 49 of the corrugation rollers 41 come into abutment with the sheet bundle, the amount of corrugation is small.

### (2) When the Number of Sheets in a Sheet Bundle is Large

When the number of sheets that the controller 24 is notified by the MFP 2 is larger than the threshold value, the controller 24 causes the bent portion of the sheet bundle to pass through the discharge rollers 37 in the substantially same manner as in the example shown in FIG. 8A.

The controller 24 rotates the motor 44 in the normal direction. At the time of normal rotation, the clutches 45 idle. The corrugation rollers 41 idle with respect to the shaft 43.

The lock members 51 lock the shouldered portions 50. The corrugation rollers 41 are restricted from rotating in the normal direction. The corrugation rollers 41 keep standstill.

The discharge rollers 37 and the pinch rollers 40 rotate. The sheet bundle proceeds leftward.

At the time of the normal rotation, the small-diameter portions 49 of the corrugation rollers 41 come into contact with the sheet bundle. The amount of corrugation is small because of being pressed by the small-diameter portions 49.

FIG. 8B shows an axial cross-sectional structure of the sheet folding mechanism 42 in a state in which the sheet bundle is advanced to the farthest position.

After the passage of the bent portion of the sheet bundle through the nip, when the corresponding portion proceeds by a distance L, the sheet folding mechanism 42 stops carrying the sheet bundle once.

The controller 24 stops the rotation of the motor 44 when the number of pulses of an encoder of the motor 44 reaches a predetermined value. The distance L that the leading end of the sheet bundle advances is substantially equal to a half of a length of a circumference of the discharge roller 37.

Subsequently, the sheet folding mechanism 42 switches back the sheet bundle.

FIG. 8C is a drawing showing an axial cross-sectional structure of the sheet folding mechanism 42 in a state in which the sheet bundle starts returning.

The controller 24 rotates the motor 44 in the reverse direction. The corrugation rollers 41 start rotating in the reverse direction together with the shaft 43. The sheet bundle move backward toward the right.

FIG. 8D is a drawing showing an axial cross-sectional structure of the sheet folding mechanism 42 in a state in which the corrugation rollers 41 rotate in the reverse direction.

At the time of reverse rotation, the shaft 43 and the corrugation rollers 41 rotate together. The motor 44 rotates the discharge rollers 37 in the reverse direction. The nip carries the sheet bundle rightward. The sheet bundle returns to its original position.

FIG. 9B is a front view showing deep corrugation that the sheet folding mechanism 42 applies to the sheet bundle.

At the time of reverse rotation, the large-diameter portions 48 of the corrugation rollers 41 come into contact with the sheet bundle. The amount of corrugation is large because of being pressed by the large-diameter portions 48. The amount of corrugation is increased at the bent portions of the sheet bundle.

A sufficient amount of corrugation is applied to the sheet bundle. The amount of corrugation can be changed according to the number of sheets in the sheet bundle. An adequate amount of corrugation can be applied.

### First Modification

When the number of sheets is large, the finisher 1 may control the corrugation rollers 41 to be stopped in a state of being rotated by a half turn in advance.

FIG. 10 is a drawing showing an axial cross-sectional structure of a sheet folding mechanism according to a first modification. Reference signs which are already described indicate the same components.

A sheet folding mechanism 42A includes the corrugation rollers 41 and a stopper 53 configured to stop excessive rotation of the corrugation rollers 41.

The controller 24 rotates the corrugation rollers 41 by a half turn so that the large-diameter portion 48 is directed upward. The stopper 53 prevents the corrugation rollers 41 from idling in the normal direction. The corrugation rollers 41 wait until the sheet bundle arrives.

A large amount of corrugation can be applied to the sheet bundle without performing a switchback operation. Therefore, speeding up of operation is achieved.

### Second Modification

The finisher 1 may apply the corrugation indirectly to the sheet bundle via a separate member instead of pressing the corrugation rollers 41 directly against the sheet bundle.

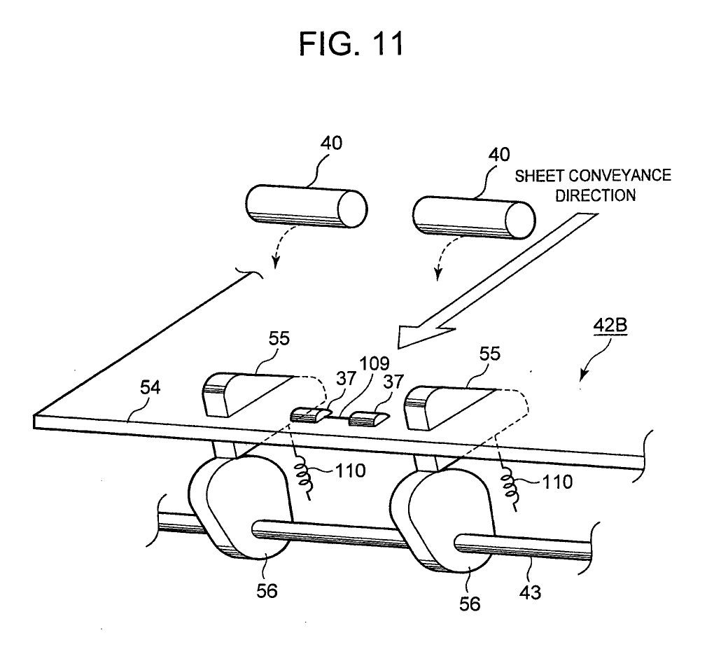

FIG. 11 is a perspective view of a sheet folding mechanism according to a second modification.

A sheet folding mechanism 42B includes a guide plate having a surface which allows the sheet bundle discharged from the saddle machine 5 to be carried thereon, and the pair of discharge rollers 37 exposing upper surfaces thereof from two holes formed on the guide plate 54.

The guide plate 54 rotatably and movably supports the discharge rollers 37. The discharge rollers 37 rotate about a shaft 109 (first shaft).

The sheet folding mechanism 42B includes a pair of blades 55 exposing upper surfaces thereof from separate two slit holes formed on the guide plate 54, and a pair of cams 56 coming into contact with lower portions of the respective blades 55 and having no clutch.

The sheet folding mechanism 42B includes the shaft 43 (second shaft) extending in parallel with the shaft 109.

The two blades 55 are configured to be capable of shifting in the vertical direction.

The respective blades 55 receive a force to move downward from coil springs 110 (springs).

Positions of upper portions of the blades 55 positioned at the lowermost level are higher than the height of the discharge rollers 37.

The cams 56 are driven to rotate. The cams 56 push the blades 55 upward and downward. The cams 56 serve to vary the amount of projection of the blades 55 with reference to a guide surface of the guide plate 54.

The discharge rollers 37 carry the sheet bundle. If the amount of projection of the blades 55 is large, the amount of corrugation is also large. If the amount of projection of the blades 55 is small, the amount of corrugation is small.

The controller 24 controls the cams 56 so that the large-diameter portions 48 face upward according to the rotation of the discharge rollers 37.

The corrugation is applied when the sheet bundle comes out.

### Second Embodiment

A sheet post-processing apparatus according to an embodiment may be configured to additionally fold the folding line of the sheet bundle output from the corrugation rollers 41.

A sheet post-processing apparatus according to a second embodiment is a finisher. A sheet folding mechanism according to the second embodiment is a sheet folding mechanism. The finisher and the sheet folding mechanism have substantially the same configuration as the finisher 1 and the sheet folding mechanism 42.

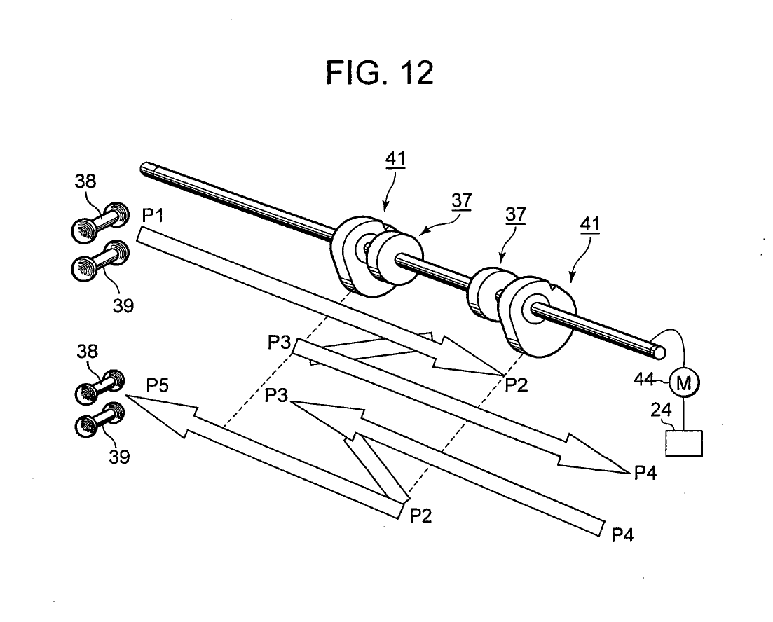

FIG. 12 is a drawing for explaining control of reciprocal movement of the upper additional folding roller 38 and the lower additional folding roller 39 of the finisher 1. Reference signs which are already described indicate the same components.

The controller 24 causes the upper additional folding roller 38 and the lower additional folding roller 39 to sharpen the folding line by a plurality of times.

In the control of the reciprocal movement by the controller 24, the distance between the corrugation rollers 41 with the clutches 45 is set to be a stroke of the reciprocal movement of the roller unit 60.

The ROM of the controller 24 stores a program for reciprocating the roller unit 60.

The sheet post-processing apparatus according to the second embodiment has substantially the same configurations as the example in the first embodiment except for the contents of control.

The finisher 1 having the controller 24 having the above-described program installed therein receives a command of folding from the MFP 2. The finisher 1 receives information on sheet size, sheet orientation, and the number of the sheets from the MFP 2.

The finisher 1 guides the sheet from the sheet branching portion 7 to the saddle machine 5. The finisher 1 causes the saddle machine 5 to produce the sheet bundle and discharge the booklet.

When the number of sheets in the booklet is small, the controller 24 reciprocates the upper additional folding roller 38 and the lower additional folding roller 39 simply across the width of the sheet of the booklet.

When the number of sheets in the booklet is large, the controller 24 firstly returns the upper additional folding roller 38 and the lower additional folding roller 39 to a home position P1.

The controller 24 causes the upper additional folding roller 38 and the lower additional folding roller 39 to move from the home position P1 to a position P2.

The controller 24 causes the upper additional folding roller 38 and the lower additional folding roller 39 to move from the position P2 to a position P3. The controller 24 causes the upper additional folding roller 38 and the lower additional folding roller 39 to move from the position P3 to a position P4.

Subsequently, the controller 24 causes the upper additional folding roller 38 and the lower additional folding roller 39 to move to a position P5 via the position P4, the position P3, and the position P2.

The upper additional folding roller 38 and the lower additional folding roller 39 sharpen the folding line of the booklet by reciprocating over the folding line of the booklet.

The controller 24 reciprocates the upper additional folding roller 38 and the lower additional folding roller 39 by a plurality of times.

A sufficient amount of corrugation is applied to the booklet having a large number of sheets.

### Third Embodiment

In the first embodiment, if the distance between the discharge rollers 37 and the corrugation rollers 41 adjacent thereto is small, an angle of the sheet becomes steep (see FIG. 9B). The finisher 1 applies deep corrugation to the sheet bundle.

In contrast, if the distance is large, the finisher 1 can only apply light corrugation to the sheet bundle.

A sheet post-processing apparatus according to a third embodiment is the finisher 1 having a mechanism to vary the distance between the corrugation rollers 41 and the discharge rollers 37.

A sheet folding mechanism according to the third embodiment is the sheet folding mechanism 42 which additionally includes a member to vary the positions of the corrugation rollers 41.

As regards other points, the sheet post-processing apparatus according to the third embodiment has substantially the same configurations as the finisher 1 in the first embodiment.

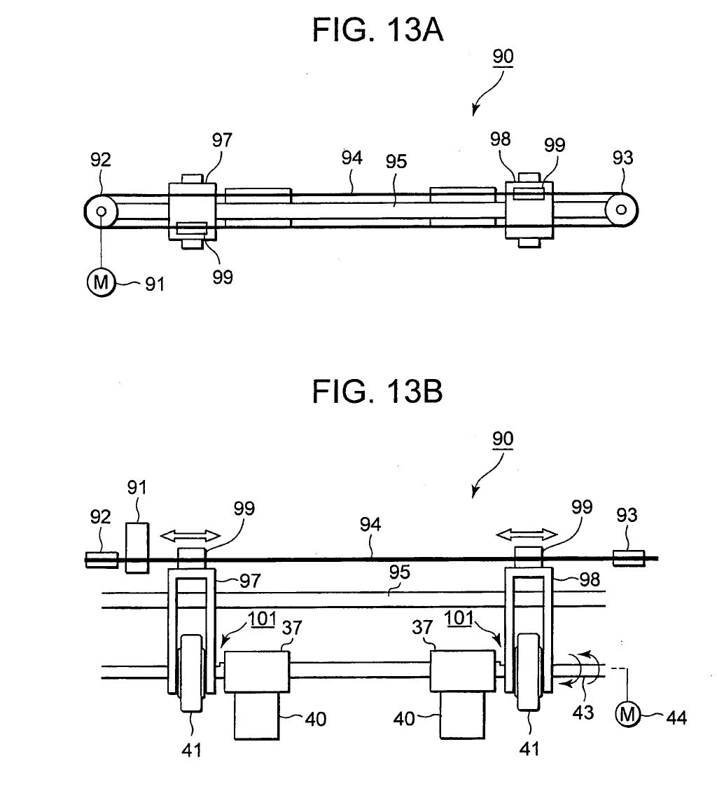

FIG. 13A is a front view of the sheet folding mechanism according to the third embodiment. FIG. 13B is a top view of the sheet holding mechanism according to the third embodiment.

FIGS. 13A and 13B show an example of a direction viewing from the destination toward the original position of the sheet bundle. Reference signs which are already described indicate the same components.

A sheet folding mechanism 90 includes a motor 91, a pulley 92 driven by the motor 91, a driven pulley 93, and a belt 94 entrained about the pulleys 92 and 93.

The sheet folding mechanism 90 includes a guide rail 95 and the shaft 43. The guide rail 95 and the shaft 43 extend in parallel to each other. The finisher 1 supports the guide rail 95 horizontally in a frame in the interior thereof.

The sheet folding mechanism 90 includes holders 97 and 98 fixed respectively to the belt 94. The holders 97 and 98 are members for varying the positions of the corrugation rollers 41 (a roller position variable member).

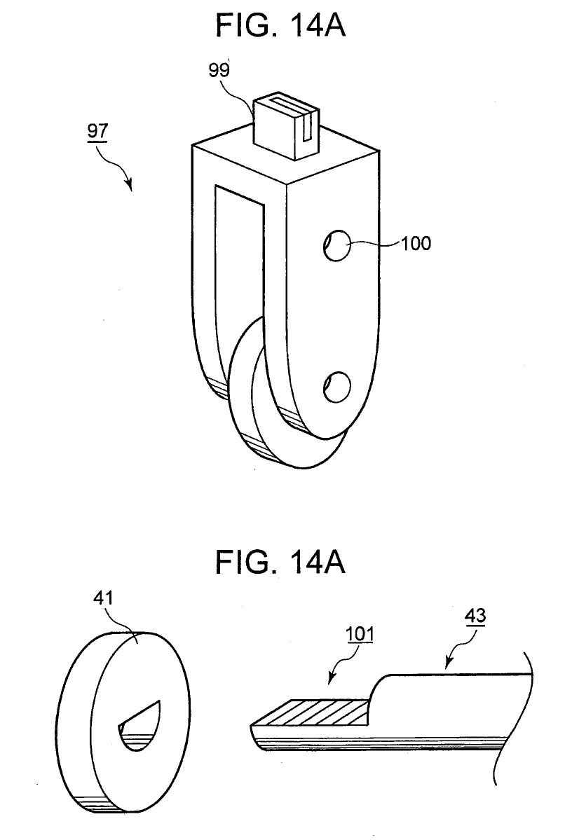

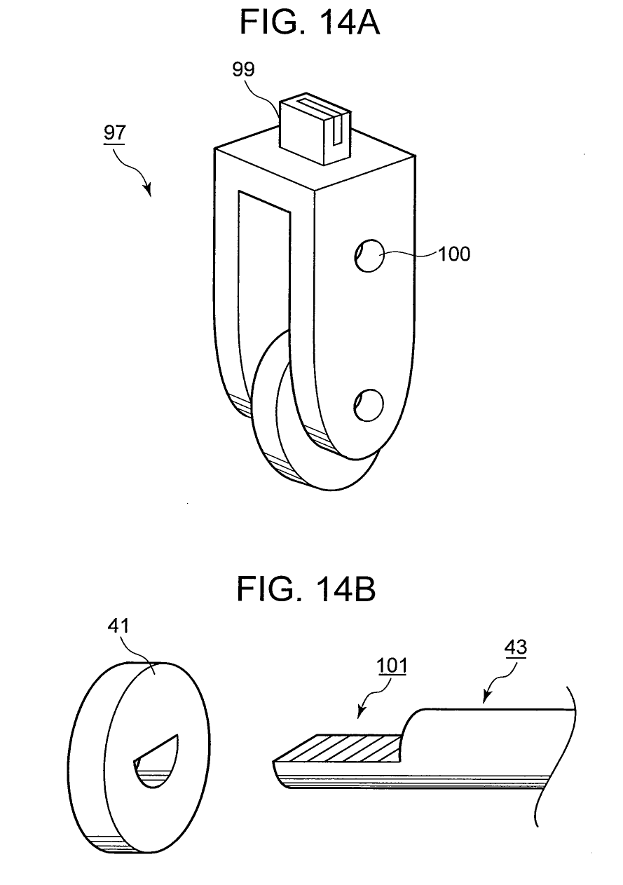

FIG. 14A is a perspective view of the holder 97.

The holder 97 is fixed to the belt 94 by a bracket 99. The holder 97 includes a guiding hole 100. The guide rail 95 penetrates the holder 97 through the hole 100.

The holder 97 is axially supported by the shaft 43 while pinching the corrugation roller 41 by a holder portion.

FIG. 14B is an enlarged view of one of D-cut portions formed on the shaft 43. D-cut portions 101 are formed by removing a semi-cylindrical shape from the rod-shaped shaft 43. The D-cut portions 101 each have a D-shape when viewed from a cross-section orthogonal to the shaft.

Shaft holes of the corrugation rollers 41 are machined in advance so as to have the same shape as the D-cut portions 101.

The holder 97 is movable leftward and rightward. The holder 97 is movable with respect to the shaft 43.

The holder 98 is substantially the same as the holder 97.

The belt 94 shown in FIGS. 13A and 13B includes a portion extending from the pulley 92 to the pulley 93 and a portion extending from the pulley 93 to the pulley 92. The directions of movement of these portions are opposite from each other.

The holder 97 is fixed to one of these portions of the belt 94. The holder 98 is fixed to the other portion of the belt 94. A distance between the holder 97 and the holder 98 is reduced and increased by the rotation of the pulleys 92 and 93.

The finisher 1 according to the third embodiment configured as described above receives a command of folding from the MFP 2.

The finisher 1 receives information on sheet size, sheet orientation, and the number of the sheets from the MFP 2. The finisher 1 causes the saddle machine 5 to produce the sheet bundle and discharge the booklet.

When the number of sheets in the booklet is small, the controller 24 increases the distance between the respective discharge rollers 37 and the corrugation rollers 41 so that application of excessive corrugation to the booklet is avoided.

When the number of sheets in the booklet is large, the controller 24 reduces the distance between the respective discharge rollers 37 and the corrugation rollers 41 so that application of corrugation to the booklet is ensured.

The sheet folding mechanism 90 applies an adequate amount of corrugation to the booklet according to the number of sheets of the booklet by varying the distance according to the number of sheets in the booklet.

The corrugation rollers 41 are coupled to the D-cut portions 101 of the shaft 43 of the discharge rollers 37. When the shaft 43 is rotated by the motor 44, the respective pairs of the discharge rollers 37 and the corrugation rollers 41 rotate together.

The holders 97 and 98 move the respective corrugation rollers 41 axially on the D-cut portions 101. The positions of the corrugation rollers 41 change.

The holders 97 and 98 fixed to the belt 94 are driven by the pulleys 92 and 93. The holders 97 and 98 move by being guided by the guide rail 95.

The sheet folding mechanism 90 varies the positions of the respective corrugation rollers 41 by varying the distance between the holders 97 and 98. The sheet folding mechanism 90 varies the distance between the respective corrugation rollers 41 and the discharge rollers 37.

Granted that the corrugation rollers 41 do not rotate, friction occurs between the corrugation rollers 41 and the sheet. The D-cut portions 101 reliably rotate the corrugation rollers 41. The D-cut portions 101 do not cause friction. Therefore, degrading of image on the sheet does not occur.

The shaft 43 may be machined into various cross-sectional shapes except for a circle instead of the D-shape. The shaft 43 may employ shapes which do not cause slippage of the corrugation rollers 41 on the outer periphery of the shaft 43.

The shaft 43 may be formed with, for example, a projection or a groove on the outer periphery thereof, so as to accommodate bearings of the corrugation rollers 41.

### Modification

The controller 24 may employ a distance set by a user instead of referencing a ROM table which stores the distance in advance.

It may also be configured to vary the distance between the corrugation rollers 41 using an operation panel. The finisher 1 sets distance information input via the operation panel from the MFP 2 to activate the corrugation rollers 41.

### Other Modifications

The configuration of the clutches 45 shown in FIGS. 7A and 7B and the configurations shown in FIGS. 1 to 6 are illustrated as examples only, and may be modified as needed. The advantages of the sheet post-processing apparatus according to the embodiments are not impaired at all by the invention implemented by modifying the structures as described above.

The number of the corrugation rollers 41 on the shaft 43 of the saddle machine 5 may be three or more.

Although each of the corrugation rollers 41 has the single shouldered portion 50, it may have a plurality of the shouldered portions 50. Each of the corrugation rollers 41 may be formed with a plurality of notches on the outer periphery thereof instead of the shouldered portion 50.

The pair of corrugation rollers 41 are provided on the shaft 43 outsides the pair of discharge rollers 37. However, the pair of the corrugation rollers 41 may be provided inside the pair of the discharge rollers 37.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. A sheet folding mechanism comprising:
a folding unit configured to form a folding line by folding a center of a sheet bundle having a plurality of sheets;
a shaft positioned on an output side of the folding unit and having a horizontal shaft axis orthogonal to the carrying direction in which the sheet bundle is carried;
a pair of discharge rollers provided on the shaft in the longitudinal direction thereof;
a pair of pinch rollers configured to nip the sheet bundle in cooperation with the pair of discharge rollers;
a pair of clutches configured to transmit a rotational force about the shaft axis only in a reverse direction opposite from a normal direction which causes the sheet bundle to be discharged;
a pair of corrugation rollers, each of the corrugation rollers having a cam surface including a first diameter portion having a diameter larger than a diameter of the discharge roller and a second diameter portion having a diameter smaller than the diameter of the first diameter portion on an outer peripheral surface thereof, and an eccentric bearing to be fixed to each of the pair of clutches inside the outer peripheral surface;
a lock member configured to prevent the pair of corrugation rollers from idling about the shaft axis in the direction to cause the sheet bundle to be discharged;
a drive unit configured to rotate the shaft in the normal direction and the reverse direction, and
a controller configured to control driving of the drive unit and cause the corrugation rollers to apply corrugation on the sheet bundle using any one of the first diameter portions and the second diameter portions according to the number of sheet in the sheet bundle.

2. The mechanism of claim 1, wherein the controller rotates the discharge rollers to the normal direction and causes the corrugation rollers to press the second diameter portions thereof against the sheet bundle having a smaller number of sheets than a threshold number of sheets stored in advance.

3. The mechanism of claim 2, wherein
the controller rotates the discharge rollers in the normal direction until the folding line of the sheet bundle passes through the discharge rollers, and then rotates the discharge rollers in the reverse direction to move the sheet bundle backward.

4. The mechanism of claim 1, wherein
the controller rotates the discharge rollers to the reverse direction to rotate the corrugation rollers in the reverse direction together with the clutches, and causes the corrugation rollers to press the first diameter portions thereof against the sheet bundle having a larger number of sheets than a threshold number of sheets stored in advance.

5. The mechanism of claim 1, further comprising:
a stopper configured to stop excessive rotation of the corrugation rollers in the normal direction, wherein
the controller rotates the discharge rollers to the reverse direction to rotate the corrugation rollers in the reverse direction together with the clutches, and then causes the stopper to stop the corrugation rollers.

6. The mechanism of claim 1, wherein
the cam surfaces of the corrugation rollers each include a shouldered portion which connects the first diameter portion and the second diameter portion; and
the lock member engages the shouldered portions to stop idling of the corrugation rollers.

7. The mechanism of claim 1, further comprising:
a guide plate having a surface to allow the sheet bundle to be carried thereon and a plurality of holes formed on the surface;
a pair of blades configured to be displaced upward and downward with respect to the surface through the plurality of holes; and
a plurality of springs configured to provide the pair of blades with a downwardly restoring force, wherein
the pair of discharge rollers carry the sheet bundle on the surface of the guide plate,
the controller causes the pair of blades to take a position to apply an upward force and a position to release the force by the respective first diameter portions of the pair of corrugation rollers.

8. The mechanism of claim 1, further comprising:
a pair of upper and lower additional folding rollers positioned upstream of the discharge rollers in the carrying direction and configured to sharpen the folding line of the sheet bundle; and
a drive mechanism configured to move the pair of additional folding rollers horizontally along the direction orthogonal to the carrying direction, wherein
the controller controls the drive mechanism, and causes the pair of additional folding rollers to make a reciprocal movement with travel of a distance between the pair of corrugation rollers.

9. A sheet folding mechanism comprising:
a folding unit configured to form a folding line by folding a center of a sheet bundle having a plurality of sheets;
a shaft positioned on an output side of the folding unit and having a horizontal shaft axis orthogonal to the carrying direction in which the sheet bundle is carried;
a pair of discharge rollers provided on the shaft in the longitudinal direction thereof;
a pair of pinch rollers configured to nip the sheet bundle in cooperation with the pair of discharge rollers;
a pair of corrugation rollers each having a cam surface on an outer peripheral surface thereof, and an eccentric bearing provided inside the outer peripheral surface and axially supported by the shaft so as to be movable in the direction of the shaft axis;
a roller position variable member configured to vary a distance between the pair of corrugation rollers;
a drive unit configured to rotate the shaft in a normal direction and a reverse direction opposite from the normal direction; and
a controller configured to control driving of the drive unit and cause the roller position variable member to vary the distance according to the number of sheets in the sheet bundle.

10. The mechanism of claim 9, wherein
the roller position variable member includes:
a guide rail parallel to the shaft axis of the shaft;
two pulleys rotating about an axis orthogonal to the guide rail;
an endless belt entrained about the respective pulleys and having a first portion traveling in a first direction directing from one end to the other end of the guide rail and a second portion traveling in a second direction opposite from the first direction;
a first holder fixed to the first portion of the belt, guided along the guide rail in the first direction, and configured to grip one of the pair of corrugation rollers; and
a second holder fixed to the second portion of the belt, guided along the guide rail in the second direction, and configured to grip the other one of the pair of corrugation rollers.

11. The mechanism of claim 9, wherein
the shaft is applied with machining for restricting slippage between an outer periphery of the shaft and the eccentric bearings of the pair of corrugation rollers.

12. The mechanism of claim 11, wherein
the shaft is cut in advance so as to assume a D-shape with a surface orthogonal to the shaft axis.

13. The mechanism of claim 9, wherein
the controller causes the roller position variable member to reduce the distance and causes the pair of corrugation rollers to apply corrugation on the sheet bundle having the number of sheets larger than a threshold number of sheets stored in advance.

14. The mechanism of claim 9, wherein
the controller causes the roller position variable member to increase the distance and causes the pair of corrugation rollers to apply corrugation on the sheet bundle having the number of sheets smaller than a threshold number of sheets stored in advance.

15. A sheet post-processing apparatus comprising:
a folding unit configured to form a folding line by folding a center of a sheet bundle having a plurality of sheets printed by and output respectively from an image forming apparatus;
a receiving unit configured to receive information on the number of sheets from the image forming apparatus;
a shaft positioned on an output side of the folding unit and having a horizontal shaft axis orthogonal to the carrying direction of the sheet bundle;
a pair of discharge rollers provided on the shaft in the longitudinal direction thereof;
a pair of pinch rollers configured to nip the sheet bundle in cooperation with the pair of discharge rollers;
a pair of clutches configured to transmit a rotational force about the shaft axis only in the direction opposite from the normal direction which causes the sheet bundle to be discharged;
a pair of corrugation rollers, each of the corrugation rollers having a cam surface including a first diameter portion having a diameter larger than a diameter of the discharge roller and a second diameter portion having a diameter smaller than the diameter of the first diameter portion on an outer peripheral surface thereof, and an eccentric bearing to be fixed to each of the pair of clutches inside the outer peripheral surface;
a lock member configured to prevent the pair of corrugation rollers from idling about the shaft axis in the direction to cause the sheet bundle to be discharged;
a drive unit configured to rotate the shaft in the normal direction and the reverse direction, and a controller configured to control driving the drive unit and cause the corrugation rollers to apply corrugation on the sheet bundle using any one of the first diameter portions and the second diameter portions according to the information on the number of sheets that the receiving unit receives, and a threshold value stored in advance.

16. The apparatus of claim 15, wherein
the controller rotates the discharge rollers to the normal direction and causes the corrugation rollers to press the second diameter portions thereof against the sheet bundle having a smaller number of sheets than a threshold number of sheets stored in advance.

17. The apparatus of claim 16, wherein
the controller rotates the discharge rollers until the folding line of the sheet bundle passes through the discharge rollers in the normal direction, and then rotates the discharge rollers in the reverse direction to move the sheet bundle backward.

18. The apparatus of claim 15, wherein
the controller rotates the discharge rollers to the reverse direction to rotate the corrugation rollers in the reverse direction together with the clutches, and causes the corrugation rollers to press the first diameter portions thereof against the sheet bundle having a larger number of sheets than a threshold number of sheets stored in advance.

19. The apparatus of claim 15, wherein
the controller varies the direction of rotation and the amount of rotation of the discharge rollers on the basis of the information on the number of sheets and varies the amount of corrugation to be applied on the folding line of the sheet bundle.

20. The apparatus of claim 15, comprising:
a pair of upper and lower additional folding rollers positioned upstream of the discharge rollers in the carrying direction and configured to sharpen the folding line of the sheet bundle; and
a drive mechanism configured to move the pair of additional folding rollers horizontally along the direction orthogonal to the carrying direction, wherein
the controller controls the drive mechanism, and causes the pair of additional folding rollers to make a reciprocal movement with travel of a distance between the pair of corrugation rollers.

21. A sheet post-processing apparatus comprising:
a folding unit configured to form a folding line by folding a center of a sheet bundle having a plurality of sheets printed by and output respectively from an image forming apparatus;
a receiving unit configured to receive information on the number of sheets from the image forming apparatus;
a shaft positioned on an output side of the folding unit and having a horizontal shaft axis orthogonal to the carrying direction of the sheet bundle;
a pair of discharge rollers provided on the shaft in the longitudinal direction thereof;
a pair of pinch rollers configured to nip the sheet bundle in cooperation with the pair of discharge rollers;
a pair of corrugation rollers each having a cam surface on an outer peripheral surface thereof, and an eccentric bearing provided inside the outer peripheral surface and axially supported by the shaft so as to be movable in the direction of the shaft axis;
a roller position variable member configured to vary a distance between the pair of corrugation rollers;
a drive unit configured to rotate the shaft in a normal direction and a reverse direction opposite from the normal direction; and
a controller configured to control driving of the drive unit and cause the roller position variable member to vary the distance on the basis of the information on the number of sheets received by the receiving unit and a threshold value held in advance.

22. The apparatus of claim 21, wherein
the roller position variable member includes:
a guide rail parallel to the shaft axis of the shaft;
two pulleys rotating about an axis orthogonal to the guide rail;
an endless belt entrained about the respective pulleys and having a first portion traveling in a first direction directing from one end to the other end of the guide rail and a second portion traveling in a second direction opposite from the first direction;
a first holder fixed to the first portion of the belt, guided along the guide rail in the first direction, and configured to grip one of the pair of corrugation rollers; and
a second holder fixed to the second portion of the belt, guided along the guide rail in the second direction, and configured to grip the other one of the pair of corrugation rollers.

23. The apparatus of claim 21, wherein
the shaft is cut in advance so as to assume a D-shape with a surface orthogonal to the shaft axis.

24. The apparatus of claim 21, wherein
the controller causes the roller position variable member to reduce the distance and causes the pair of corrugation rollers to apply corrugation on the sheet bundle having the number of sheets larger than a threshold number of sheets stored in advance.

25. The apparatus of claim 21, wherein
the controller causes the roller position variable member to increase the distance and causes the pair of corrugation rollers to apply corrugation on the sheet bundle having the number of sheets smaller than a threshold number of sheets stored in advance.

26. A method of applying corrugation on the sheet, comprising:
forming a folding line by folding a center of a sheet bundle having a plurality of sheets and sending the sheet bundle to a pair of discharge rollers;
rotating the discharge rollers in the normal direction to discharge the sheet bundle together with a pair of pinch rollers, and sending the sheet bundle to a pair of corrugation rollers via a pair of one-way clutches fixed to the shaft;
bringing any one of first diameter portions having a diameter larger than a diameter of the discharge rollers and second diameter portions having a diameter smaller than the diameter of the first diameter portions of cam surfaces on outer peripheral surfaces of the respective corrugation rollers into contact with the folding line according to the number of sheets; and
applying corrugation of different amounts to the sheet bundle using either the first diameter portions or the second diameter portions.

27. The method of claim 26, comprising:
rotating the discharge rollers in the normal direction; and
causing the corrugation rollers to press the second diameter portions thereof against the sheet bundle having a smaller number of sheets than a threshold number of sheets stored in advance.

28. The method of claim 27, comprising:
rotating the discharge rollers until the folding line of the sheet bundle passes through the discharge rollers, and then rotating the discharge rollers in the reverse direction opposite to the normal direction to move the sheet bundle backward.

29. The method of claim 26 comprising:
rotating the discharge rollers in the reverse direction opposite from the normal direction and rotating the corrugation rollers together with the clutches in the reverse direction; and
causing the corrugation rollers to press the first diameter portions thereof against the sheet bundle having a larger number of sheets than a threshold number of sheets stored in advance.

30. The method of claim 26, wherein
applying the corrugation on the sheet bundle, and then causing a pair of upper and lower additional folding rollers to make a reciprocal movement with travel of a distance between the pair of corrugation rollers.
